(19) United States
(12) Patent Application Publication
(10) Pub. No.: US 2024/0224306 A1
(43) Pub. Date: Jul. 4, 2024

(54) CONSTITUTION OF RATE-SPLITTING MULTIPLE-ACCESS USER EQUIPMENT GROUP

(71) Applicant: QUALCOMM Incorporated, San Diego, CA (US)

(72) Inventors: Ahmed ELSHAFIE, San Diego, CA (US); Marwen ZORGUI, San Diego, CA (US); Ahmed Attia ABOTABL, San Diego, CA (US); Wanshi CHEN, San Diego, CA (US)

(21) Appl. No.: 18/150,076

(22) Filed: Jan. 4, 2023

(51) Int. Cl. H04W 72/51; H04W 76/14; H04W 76/15

(52) U.S. Cl. CPC H04W 72/51; H04W 76/14; H04W 76/15; H04L 1/0003

(57) ABSTRACT

Certain aspects of the present disclosure provide techniques for rate-splitting multiple access (RSMA) for a user equipment (UE) group. An example method includes transmitting, to a group of receiver UEs (Rx UEs), an indication that the Tx UE will transmit to the group of Rx UEs using rate splitting multiple access (RSMA), and transmitting to the group using RSMA, wherein transmitting to the group using RSMA comprises: splitting individual messages intended for individual Rx UEs in the group into common messages and private messages, combining the common messages, transmitting the combined common messages using a first precoder, and transmitting the private messages using separate precoders.

### BACKGROUND

### Field of the Disclosure

Aspects of the present disclosure relate to wireless communications, and more particularly, to wireless systems using rate-splitting multiple access (RSMA).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a transmitter (Tx) user equipment (UE). The method includes transmitting, to a group of receiver UEs (Rx UEs), an indication that the Tx UE will transmit to the group of Rx UEs using rate splitting multiple access (RSMA); and transmitting to the group using RSMA, wherein transmitting to the group using RSMA comprises: splitting individual messages intended for individual Rx UEs in the group into common messages and private messages; combining the common messages; transmitting the combined common messages using a first precoder; and transmitting the private messages using separate precoders.

Another aspect provides a method for wireless communications by a first Rx UE. The method includes receiving, from a Tx UE, an indication that the Tx UE will transmit to a group of Rx UEs using RSMA, wherein the group includes the first Rx UE; receiving, from the Tx UE using RSMA, at least one common message that includes combined portions of messages intended for different UEs in the group and at least one private message intended for the first Rx UE; decoding the at least one common message using a first decoder; and decoding the at least one private message using a second decoder, based on results of decoding the at least one common message.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example framework for a channel state information (CSI) report configuration.

FIG. 6 depicts an example sidelink CSI reporting medium access control (MAC) control element (CE).

FIG. 7 depicts an example diagram illustrating techniques for transmitting using rate-splitting multiple access (RSMA), in accordance with certain aspects of the present disclosure.

FIG. 8 depicts an example diagram illustrating techniques for processing an RSMA transmission, in accordance with certain aspects of the present disclosure.

FIG. 9 depicts a call flow diagram for indicating UEs in an RSMA group, in accordance with certain aspects of the present disclosure.

FIGS. 10-16 depict examples of MAC-CE entries for a CSI report to assist in RSMA transmissions, in accordance with certain aspects of the present disclosure.

FIG. 17 depicts a method for wireless communications.

FIG. 18 depicts a method for wireless communications.

FIG. 19 depicts aspects of an example communications device.

### DETAILED DESCRIPTION

Aspects of the present disclosure provide apparatuses, methods, processing systems, and computer-readable mediums for rate-splitting multiple access (RSMA) for a user equipment (UE) group.

Rate-splitting techniques, such as Rate splitting multiple access (RSMA), have been shown to achieve higher capacity and may be a candidate for use in advanced systems, such as 6G and/or 5G-advanced. RSMA generally refers to a multiple access technique that allows multiple users to share frequency resources efficiently. RSMA allows multiple users to transmit data simultaneously over the same frequency band, but in a way that is different from conventional techniques, such as time division multiple access (TDMA) or frequency division multiple access (FDMA).

RSMA could be used for sidelink communication, for example, where individual users are user equipments (UEs). In such cases, a transmitter UE (Tx-UE) may transmit, using RSMA, to a group of receive UEs (Rx-UEs). In this context, the Tx-UE may be a regular UE, a programmable logic control, a primary UE, etc.

In RSMA, each user is assigned a specific data rate and the users transmit their data using a combination of power and rate allocation. The transmitter adjusts the power and data rate of each user's signal based on the channel conditions and the desired data rate for that user. This allows the transmitter to efficiently utilize the available resources and achieve higher spectral efficiency compared to other techniques.

In a sidelink RSMA scenario, individual messages intended for individual users (Rx-UEs) are split into common and private parts (e.g., common messages and private messages). The common parts of individual messages may be concatenated into a common message, and encoded (using a common precoder) and modulated to a common stream. The private part of the individual messages may be separately encoded (using separate precoders) and modulated to private streams for transmission to their respective Rx-UEs.

One challenge in using RSMA for sidelink communications is how to select what UEs constitute an Rx-UE group. Ideally, Rx-UEs in a group are located such that a common precoder is available that achieve acceptable results, while still allowing for increased precoding gain via the separate precoders to achieve desired data rates.

Aspects of the present disclosure provide techniques that may enable a Tx-UE to effectively determine and communicate which Rx-UEs constitute a group for RSMA communications. Certain aspects enable the Tx UE to obtain information about channel conditions associated with common and private message parts, which may be used to select which Rx-UEs constitute a group. This information may also be used to determine the precoders used for the common and private message parts.

Utilization of the techniques disclosed herein may improve spectral efficiency (SE), energy efficiency (EE), coverage, user fairness, reliability, and quality of service (QoS) for a wide range of network loads (including both underloaded and overloaded regimes) and user channel conditions.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

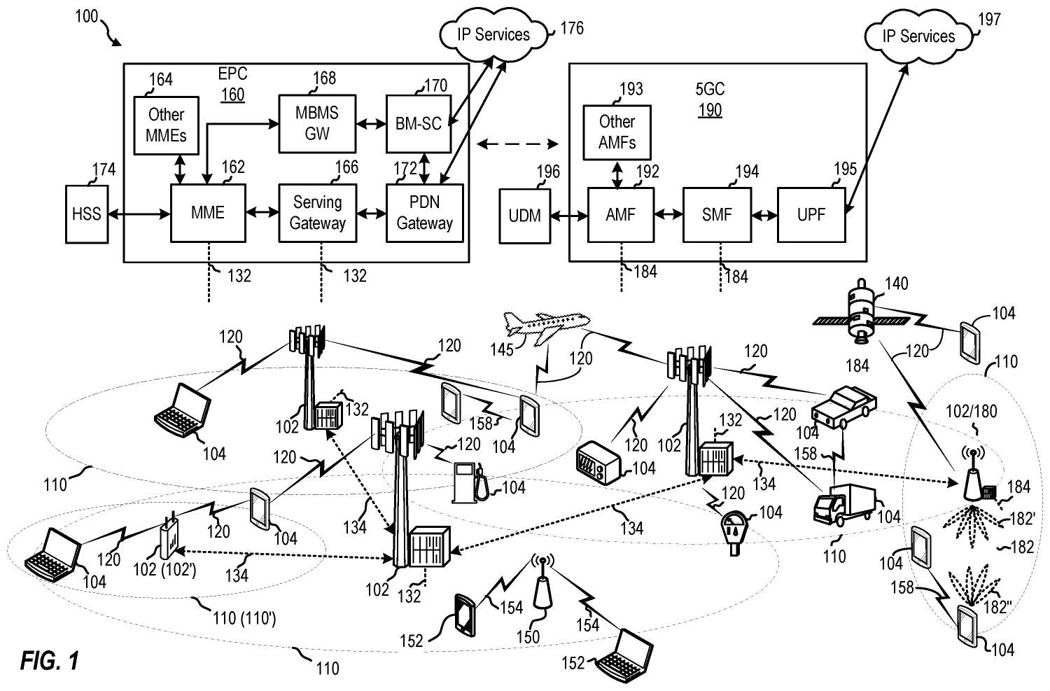

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

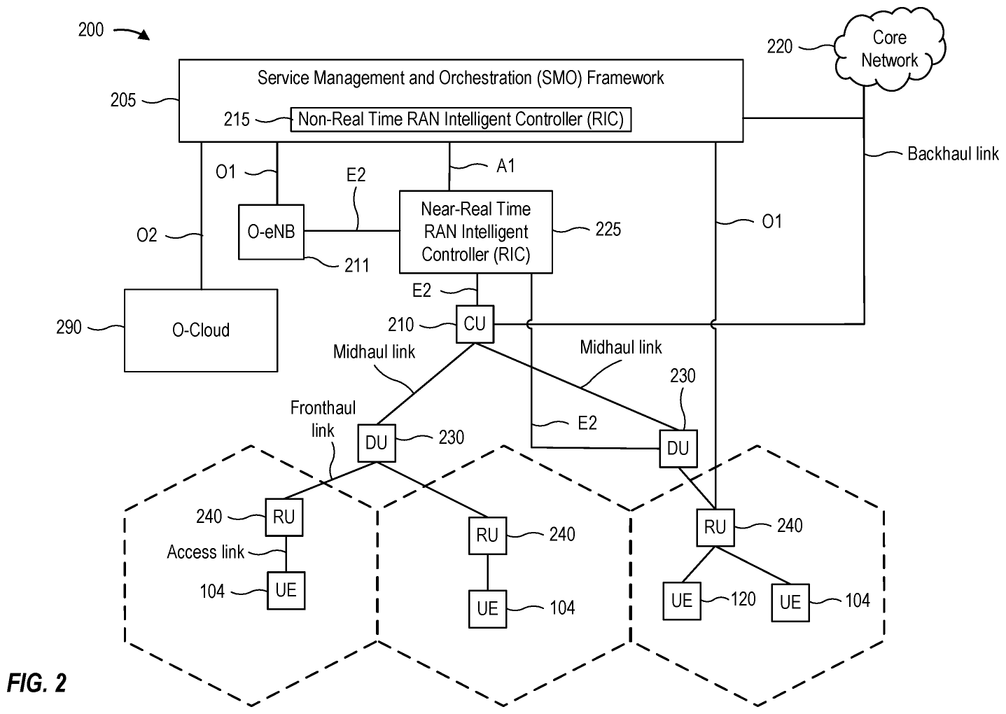

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5GNR orNext Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

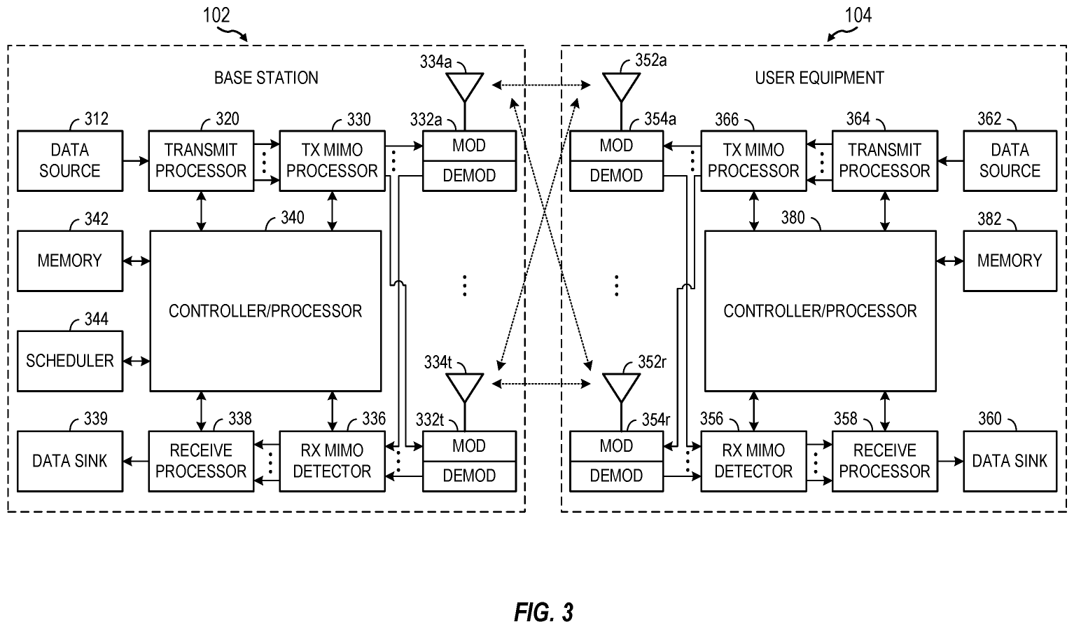

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

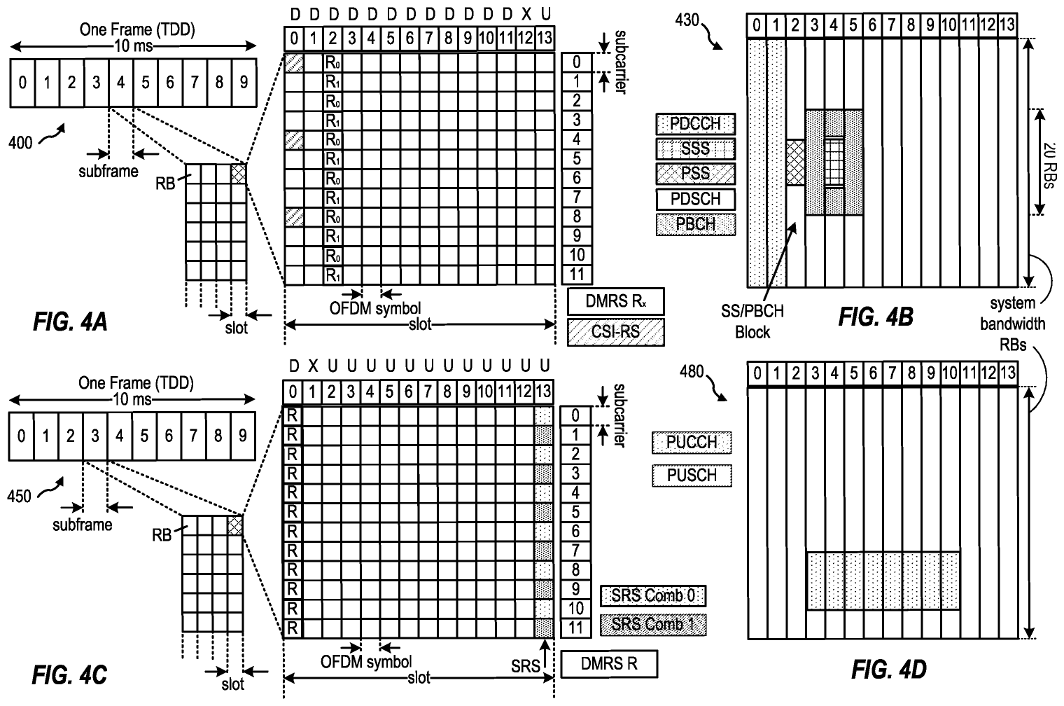

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example CSI Feedback Configuration

In certain systems, such as new radio (NR) systems, a UE is configured with N non-zero power (NZP) channel state information (CSI) reference signal (CSI-RS) resources for channel measurement (CMRs). The UE is configured to select one resource out of the configured N resources. The UE is also configured with CSI-RS resources for interference measurement (CSI-IMRs). The resources for interference measurement are associated with the configured resources for channel measurement. This CSI framework allows dynamic channel/interference hypothesis, for example, in the case of transmission by a single transmission reception point (TRP) or multiple TRPs.

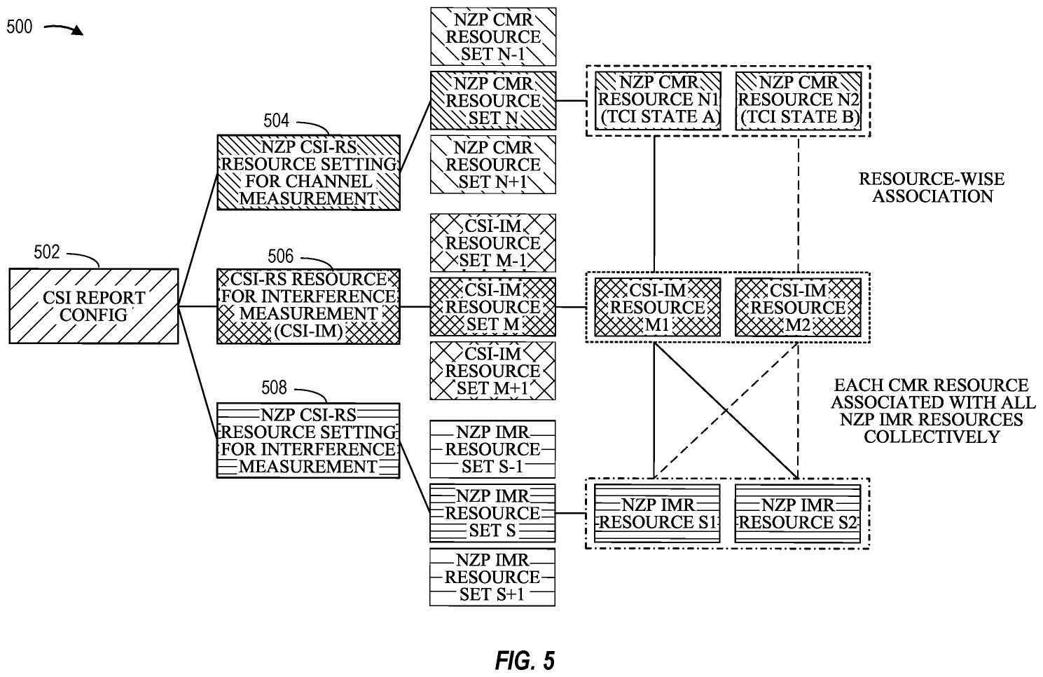

FIG. 5 illustrates an example CSI report configuration 502. As shown in FIG. 5, the CSI report configuration may configure the UE with a CMR setting 504, a CSI interference measurement (CSI-IM) setting 506, and/or with a CMR setting, CSI-IM setting, and NZP-TMR setting 508. As illustrated, each setting may be associated with multiple resource sets, each resource set including multiple resources.

In some examples, the number of resources in the CMR sets may be the same as the number of resources in the CSI-IM sets, but the number of resources in the NZP-IMR sets may be different. Each resource setting may have one active set at a given time. The active set may have up to N=8 resources, and the UE may be configured to select one resource out of N configured CMRs. The CMRs may be resource-wise associated with a CSI-IM resource and NZP-IMR set.

Each port of the NZP-IMRs may correspond to an interference layer. The NZP-IMRs and the CSI-IMs may share a Type-D QCL with the associated CMR. The UE may measure interference from the interference resources associated with the selected CMR. The UE may use the interference measurements to perform interference mitigation. The CSI report configuration supports CSI for one or more TRPs.

In a sidelink scenario, a CSI report configuration could configure resources for reporting sidelink channel conditions between UEs. In such a scenario, sidelink CSI may be used to provide information about the sidelink channel conditions between the UEs. This information can be used by the UEs to optimize their transmission and reception, and to improve overall system performance.

A UE may transmit sidelink CSI-RS within a unicast physical sidelink shared channel (PSSCH) transmission if CSI reporting is enabled (e.g., by higher layer parameter sl-CSI-Acquisition and the “CSI request” field in the corresponding SCI format 0-2 is set to 1). For CSI-RS transmission, various parameters may be configured by the higher layer signaling, for example, to indicate the number of ports for SL CSI-RS, the first OFDM symbol in a PRB used for SL CSI-RS, and frequency domain allocation for SL CSI-RS.

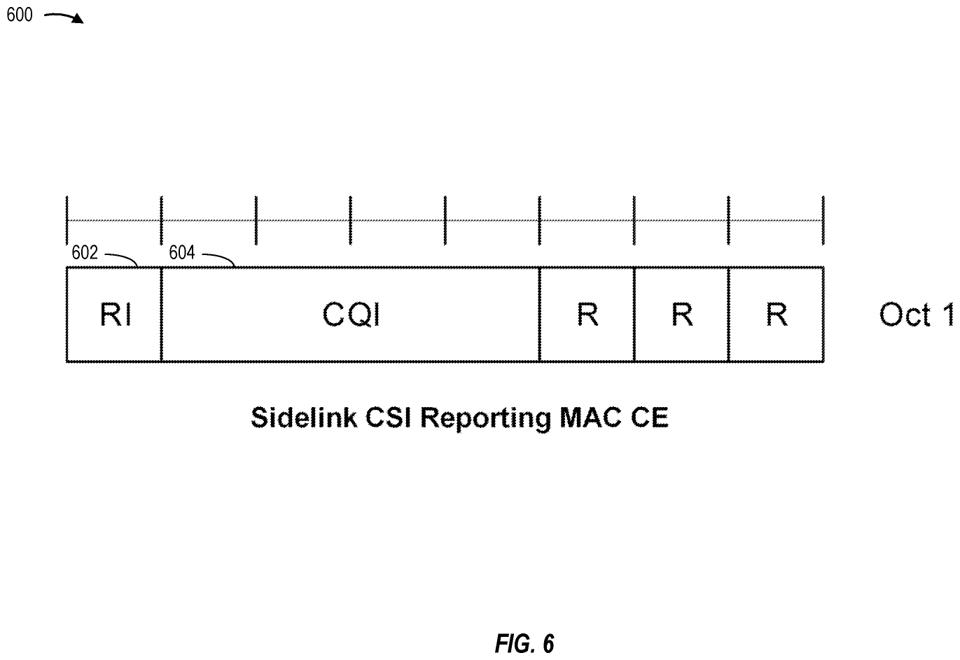

As illustrated in FIG. 6, SL CSI may be reported in a MAC CE entry 600 that includes a Rank Indicator 602 and Channel Quality Indicator (CQI) 604. The RI field 602 indicates the derived value of the Rank Indicator for sidelink CSI reporting and may be 1 bit in length. The CQI field 604 indicates the derived value of the Channel Quality Indicator for sidelink CSI reporting and may be 4 bits in length. Reserved bits (R) may be set to zero.

A UE may calculate CSI parameters (if reported) assuming various dependencies between CSI parameters (if reported). For example, CQI may be calculated conditioned on the reported RI. CSI reporting can be aperiodic and may be triggered by sidelink control information (SCI). For CSI reporting, wideband CQI reporting may supported, where a wideband CQI is reported for an entire CSI reporting band.

To control the SL-CSI reporting procedure, RRC signaling may configure a latency bound, via a parameter (sl-LatencyBound-CSI-Report) which is maintained for each RRC connection. This parameter may be in terms of slots. Triggered SL CSI reporting may be cancelled if latency requirements cannot be met. A MAC entity configured with Sidelink resource allocation mode 1 may trigger a Scheduling Request if transmission of a pending SL-CSI reporting with the sidelink grant(s) cannot fulfil the latency requirement associated to the SL-CSI reporting.

### Overview of Rate-Splitting Multiple Access (RSMA)

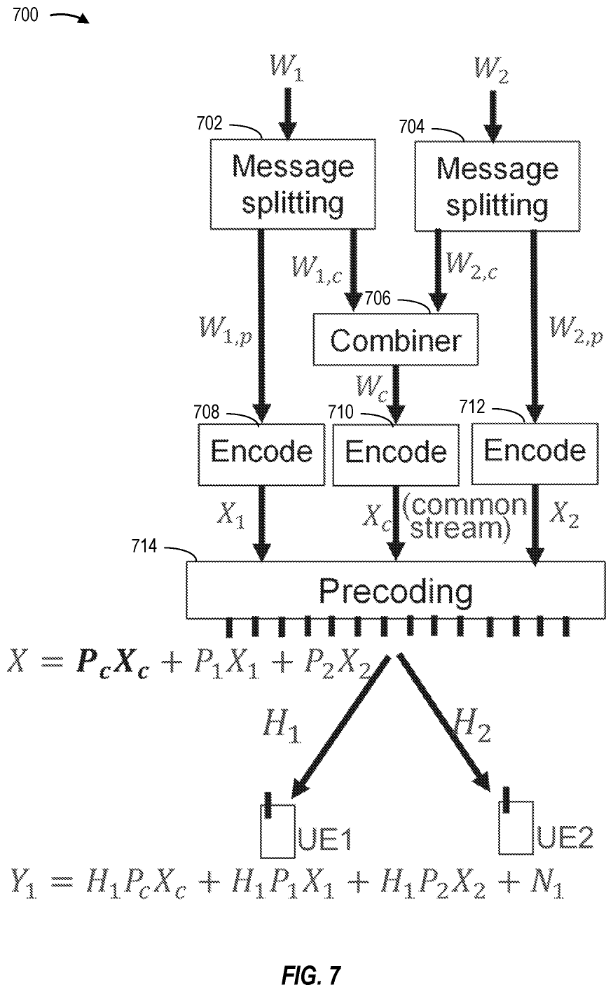

FIG. 7 depicts an example diagram 700 illustrating a processing chain for transmitting to a group of receive UEs (Rx-UEs) using rate-splitting multiple access (RSMA).

As noted above, in systems utilizing RSMA, individual messages (W₁ and W₂) intended for individual Rx-UEs (UE1 and UE2) may be split into common and private parts and transmitted as common messages and private messages. As shown, individual message W₁ may be split, at 702, into a common part W_{1,c} and a private part W_{1,p}, while individual message W₂ may be split, at 704, into a common part W_{2,c} and a private part W_{2,p}. The common parts W_{1,c} and W_{2,c} may be combined (concatenated), at 706, into a common message, W_{c}.

The common message, W_{c}, may then be encoded and modulated, at 710, (e.g., where modulation is performed as part of the encoding block in the illustrated example) to generate a common stream, X_{c}, which may have one or more layers. The common stream may then be precoded, at 714, by a precoder P_{c} and transmitted by transmit (Tx) antennas.

The private parts W_{1,p} and W_{2,p} may be separately encoded and modulated, at 708 and 712 respectively, (e.g., where modulation is performed as part of the encoding block in the illustrated example) to generate private streams, X₁ and X₂, respectively, intended for their respective corresponding UEs. The private streams X₁ and X₂ may then be precoded separately, at 714, by separate precoders, P₁ and P₂, respectively, and transmitted by Tx antennas.

In some cases, the precoders, P₁ and P₂, may be associated with narrower beams that the precoder P_{c}. Thus, the beamforming gain associated with precoders, P₁ and P₂ may be greater (e.g., from a UE perspective).

In some cases, after the common stream and private streams precoded, they may be transmitted by Tx antennas. For example, one or more of the common stream and/or private streams may be transmitted from a single network entity (e.g., a TRP or gNB) or multiple network entities (e.g., multiple TRPs in a coordinated multipoint (CoMP) scenario).

As described above, the encoding blocks illustrated in FIG. 7 may perform encoding, modulation, and mapping of their respective inputs (e.g., W_{c}, W_{1,p}, or W_{2,p}) to one or more layers of their respective output streams (e.g., X_{c}, X₁, or X₂).

The precoded transmission, X (e.g., which includes the precoded output streams X_{c}, X₁, and X₂) may be represented by the following equation:

$$X = {P}_{c} {X}_{c} + {P}_{1} {X}_{1} + {P}_{2} {X}_{2} .$$

From a receiver standpoint, each UE will receive the signal subject their own channel conditions. For example, UE1 will receive the RSMA transmission as:

$${Y}_{1} = {H}_{1} {P}_{c} {X}_{c} + {H}_{1} {P}_{1} {X}_{1} + {H}_{1} {P}_{2} {X}_{2} + {N}_{1} ,$$

where N₁ represents noise and/or interference associated with the transmission to UE1 and H₁ is the effective channel between UE1 and the transmitter. Similarly, UE2 will receive the RSMA transmission as:

$${Y}_{2} = {H}_{2} {P}_{c} {X}_{c} + {H}_{2} {P}_{1} {X}_{1} + {H}_{2} {P}_{2} {X}_{2} + {N}_{2} ,$$

where N₂ represents noise and/or interference and H₂ is the effective channel between UE2 and the transmitter.

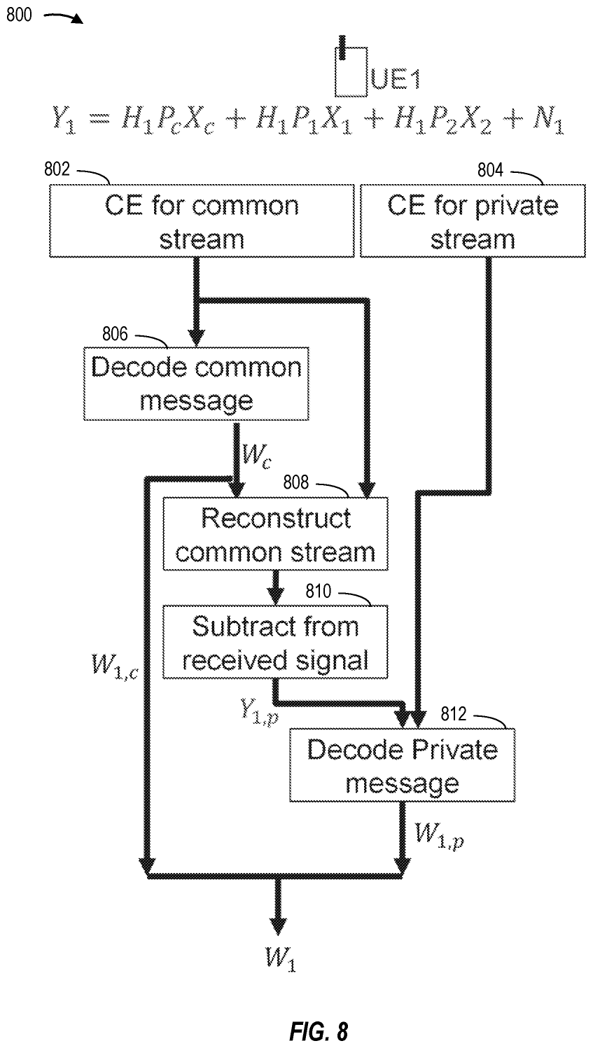

FIG. 8 depicts an example diagram 800 illustrating a processing chain for an RX-UE for processing a received RSMA transmission. The example illustrates UE1 processing RSMA signal Y₁ as described above. While not shown, UE2 may process RSMA signal Y₂ in a similar manner. In some cases, the decode blocks illustrated in FIG. 8 may perform decoding, demodulation, and demapping.

As illustrated, UE1 may perform channel estimation (CE) for the common stream, at 802, and private streams, at 804. As noted above, the common message W_{c} includes some part of the individual message for each UE (e.g., W₁ for UE1 and W₂ for UE2).

The UE1 may then use successive interference cancelation to decode the common message W_{c}, at 806. For example, UE1 may estimate the effective channel corresponding to the common stream (H₁P_{c}) and decode the common message, W_{c}. The common message and the estimated effective channel may be used to reconstruct the common stream X_{c} by re-encoding, as shown at 808. UE1 may then multiply the common stream by the estimated effective channel, which yields H₁P_{c}X_{c}, which is then subtracted from the received signal, Y₁, at 810, resulting in Y_{1,p}, which may be represented (assuming idealistic channel estimation and successful decoding) by the following equation:

$${Y}_{1 , p} = {Y}_{1} - {H}_{1} {P}_{c} {X}_{c} = {H}_{1} {P}_{1} {X}_{1} + {H}_{1} {P}_{2} {X}_{2} + {N}_{1} .$$

UE1 may then use the estimated effective channel for the private stream (e.g., H₁P₁), along with Y_{1,p} to decode the private message, at 812, yielding W_{1,p}.

The decoded common message, W_{c}, (e.g., which was computed by concatenating the common part of individual message W₁, W_{1,c}, with the common part of individual message W₂, W_{2,c}) may be de-concatenated to yield the common part of individual message W₁, W_{1,c}. W_{1,c}, in addition to the decoded private message, W_{1,p}, make up the individual message, W₁, which was initially intended for UE1.

### Aspects Related to Rate-Splitting Multiple Access (RSMA) for a User Equipment (UE) Group

As noted above, one challenge in using RSMA for sidelink communications is how to select what UEs constitute an Rx-UE group. Aspects of the present disclosure provide mechanisms that can help determine what Rx-UEs constitute an RSMA group. For example, the Rx-UEs in the group may be selected in a manner designed to optimize a common precoder for common message parts, while still allowing for increased precoding gain via the separate precoders used for private message parts.

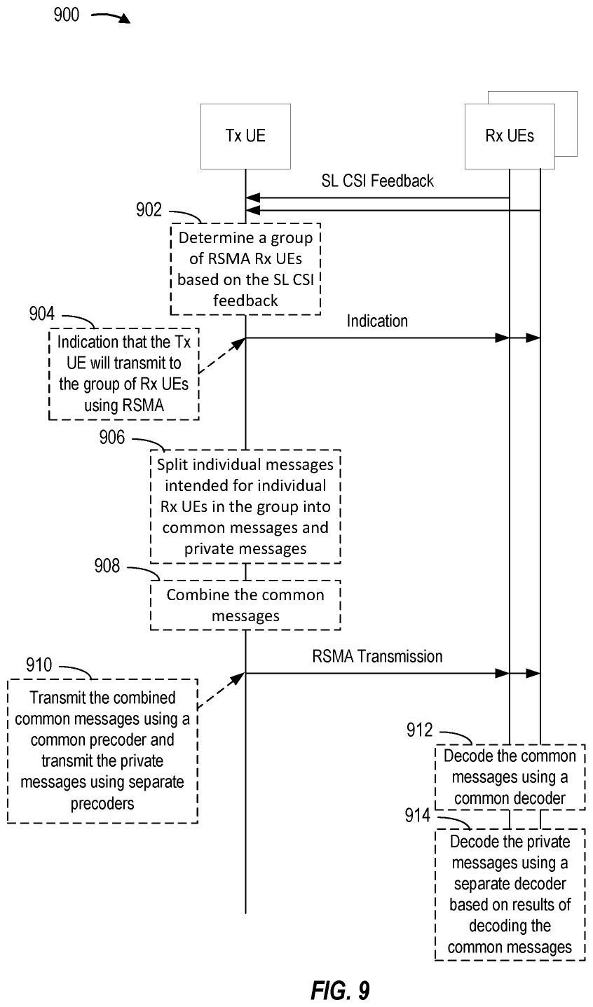

RSMA group constitution in accordance with aspects of the present disclosure may be understood with reference to the call flow diagram 900 of FIG. 9. In the illustrated example, a Tx UE signal a group of Rx UEs an indication that they will for an RSMA group. The Tx and Rx UEs shown in FIG. 9 may be examples of UE 104 depicted and described with respect to FIGS. 1 and 3. However, in other aspects, the UEs may be another type of wireless communications device.

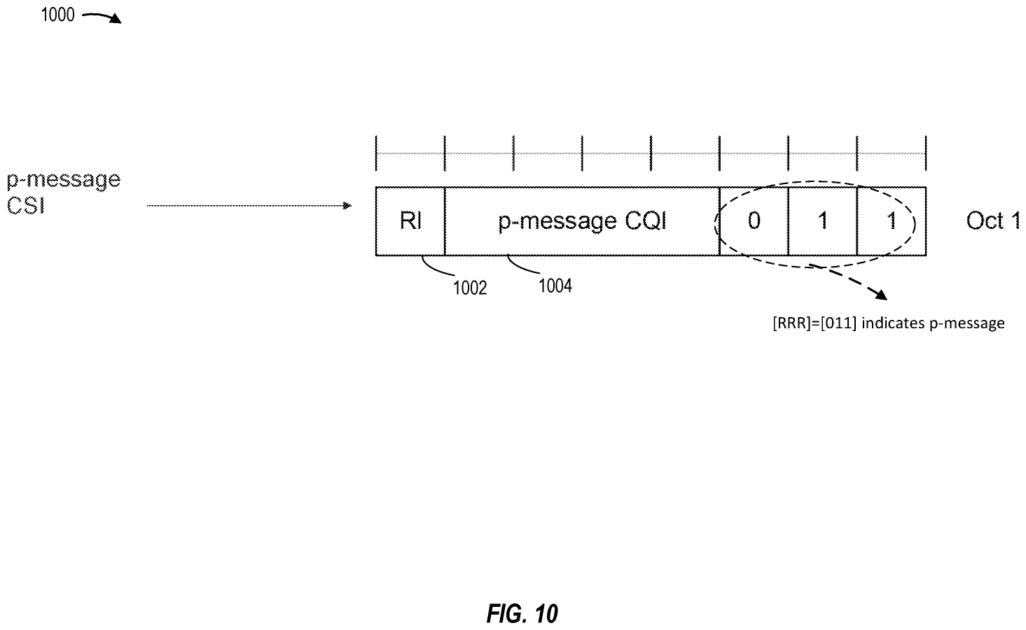

As illustrated in the call flow diagram 900, according to certain aspects, one or more of the Rx UEs may transmit sidelink CSI feedback to the Tx UE. At 902, the Tx UE may determine a group of RSMA Rx UEs based on the SL CSI feedback. The SL CSI feedback may include CSI specific to RSMA. For example, as will be described in greater detail below with reference to FIGS. 10-16, the SL CSI feedback may include CSI for both private and common message parts.

As illustrated at 904, the Tx UE may transmit an indication to the determined group of Rx UEs, indicating that the Tx UE will transmit to the group of Rx UEs using RSMA.

The Tx UE may then communicate with the group using RSMA. As illustrated at 906, the Tx UE may split individual messages intended for individual Rx UEs in the group into common messages and private messages. At 908, the Tx UE may combine the common messages.

As illustrated at 910, the Tx UE may transmit the combined common messages using a first (common) precoder and transmitting the private messages using separate precoders.

As illustrated at 912, the Rx UEs may decode the common messages using a first (common) decoder. As illustrated at 914, each Rx UE may decode their respective private messages using a separate decoder, based on the results of decoding the common messages.

In some cases, when shared resources are scheduled by the same entity (e.g., a primary UE or a gNB), the entity may indicate ports to use and co-scheduled ports for the purpose of rate-matching at the Rx UE and better channel estimation at the Rx UE. As described above, when rate splitting, a Tx-UE (similar to a gNB) can communicate with 2 Rx-UEs or more.

According to certain aspects, accommodation of new Rx-UEs into resources dedicated for Tx-UE to Rx-UE communications may be based on agreement from Tx-UE and Rx-UE. In some cases, the agreement may be based partially on which UE found (e.g., discovered/reserved) the resources.

According to certain aspects, a Tx-UE may send a request for two or more UEs (e.g., that the Tx-UE has data for) to form (constitute) a rate-splitting connection or group. Each Rx-UE may respond with its capability to perform rate splitting reception (which requires successive cancellation). In some cases, a UE capability may change over time, for example, based on energy at the UE (e.g., sometimes the UE uses a low complexity receiver process). UE capability may include a number of streams for private messages and a number of streams for common messages that can be supported by UE (e.g., since UE may perform successive cancellation). In some cases, UE capability may also indicate the processing time of various streams (e.g., which may be used to determine feedback time), or feedback time.

In some cases, each Rx-UE may respond to the request to form a rate splitting group with a required modulation coding schemes (MCS), a block error rate (BLER) value, or a combination thereof. These parameters may help the Rx-UE avoid wasting power decoding erroneous packets.

In some cases, Rx-UEs can indicate their capabilities (to support rate splitting) while performing an RRC connection procedure with the Tx-UE. In such cases, the Rx-UEs can update their capabilities from time to time (e.g., periodically or based on their battery and/or engagement with other tasks) using L1/L2/L3 signaling. In some cases, UE capabilities may be updated in response to each rate-split group request, as indicated above.

In some cases, a determination to use rate-splitting may be made based on BLER (e.g., computed based on CSI reports or measurements), based on current reported capabilities.

In some cases, as a response to a request to constitute a rate splitting group, each Rx-UE may indicate its CSI report in a physical sidelink feedback channel (PSFCH), a physical sidelink shared channel (PSSCH), or MAC-CE. The CSI may be based on a transmitted sidelink reference signal (SL-RS) which, in some cases, may be bundled with the request or multiplexed with the request, or based on one or more previously received demodulation reference signals (DMRSs), or based on filtered reference signal receive power (RSRP). The filtered RSRP may be maintained by UEs based on previous PSSCHs.

In some cases, as part of the request to form a rate splitting group, a Tx-UE may request UEs to send CSI. In some cases, as part of the request, Tx-UE can request Rx-UEs to send sounding reference signals (SRS). In such cases, Tx-UE may request Rx-UEs to transmit reference signals at a certain time on certain time/frequency resources (e.g., after a certain time offset from the request or on the same slot as the request).

In some cases, Tx-UE can specify how many UEs may participate in rate splitting. In such cases, the Tx-UE may accommodate the specified number on a first-in-first-out (FIFO) basis or their data priorities or quality of service (QoS), which may be known by Tx-UE.

In some cases, a proactive approach to form a rate splitting group of Rx UEs may be used. For example, even if there is no data at a Tx-UE at the time of connection for a certain Rx-UE, more UEs may be involved. This approach may be especially useful for configured grant scenarios. Thus, at the beginning of the connection, there could be a list of potential UEs to add to a rate splitting group.

According to certain aspects, if an Rx-UE assisted in finding resources (e.g., using inter-UE coordination), additional constraints may be added by that Rx-UE on how to use the resources. In some cases, for example, the Rx-UE may indicate to the Tx-UE to use the resources for serving that Rx-UE only. In some cases, the Rx-UE may indicate to the Tx-UE to use the resources for rate splitting transmissions under a certain number of layers (private and common) for Rx-UE. For example, in some cases, a lower number of common layers may be better for the Rx-UE to perform a successive cancellation procedure and to decrease delay in decoding the private message. In some cases, the Rx-UE may indicate to the Tx-UE to use certain power/MCS/layers/reliability/BLER for the Rx-UE.

As noted above, in some cases, SL CSI feedback may include CSI specific to RSMA, including CSI feedback corresponding to both private and common message parts. In other words, the Tx-UE may use this information to select which Rx-UEs should constitute a rate splitting group (to receive RSMA transmissions) and to determine optimal precoders for the common and private message parts.

In some cases a latency bound parameter (e.g., sl-LatencyBound-CSI-Report) may be defined and used to initialize timers for each common and private message type of CSI feedback. In such cases, CSI reporting may be cancelled partially (e.g., for just a private part or a common part) when one timer expires and/or CSI reporting may be cancelled fully (e.g., for both private and common parts) when both timers expire. In some cases, UEs may agree on a latency bound for a private part (sl-LatencyBound-CSI-Report private). This private latency bound could be the same as an expected latency bound timer and for a regular (non-RSMA) TB transmission. In some cases, an SL latency bound may be determined as a delta from a conventional latency bound, such as:

$$sl - LatencyBound - CSI - Report\_delta = sl - LatencyBound - CSI - Report\_common and sl - LatencyBound - CSI - Report\_private .$$

In other words, common message CSI may be expected to be slower to change than private message CSI, as it is used across multiple UEs. Thus, if the expiration time of private-message CSI is timer 1, then for a common-message, the expiration time is timer 2>timer 1.

In some cases, a minimum CSI report time may be defined for each type of message. This may be based on UE capability because, if PSSCH is used to derive the CSI, the UE may need to decode the common message (c-message) first. Hence, a UE may have faster access to c-message CSI than private message (p-message) CSI. This minimum CSI report time may define when exactly a Tx-UE is expected to receive (from an Rx-UE) the CSI MAC-CE of each message, or for both messages.

As noted above with reference to FIG. 6, a sidelink CSI reporting MAC-CE may be used to convey CSI between sidelink UEs. C-message and p-message CSI may be sent separately or together. In some cases, CSI for one type of message may be sent as a difference (delta) relative to the CSI for the other type of message.

FIG. 10 depicts an example MAC-CE entry 1000 that may be used for p-message CSI reporting. As illustrated, the MAC CE entry 1000 may include one or more bits to convey a rank indicator (RI) 1002 and a plurality of bits for a p-message channel quality indicator (CQI) 1004.

In some cases, (previously) reserved (R) bits may be used to indicate whether the CSI report is for a traditional (legacy) transmission, p-message, or c-message. For example, R bit values of [0 0 0] may indicate a legacy CSI. In the illustrated example, R bit values of [0 1 1] indicate report is for p-message CSI. A transmitting device can use this reported information to adjust its transmission parameters, such as the transmit power and modulation scheme, to optimize the performance of the sidelink communication.

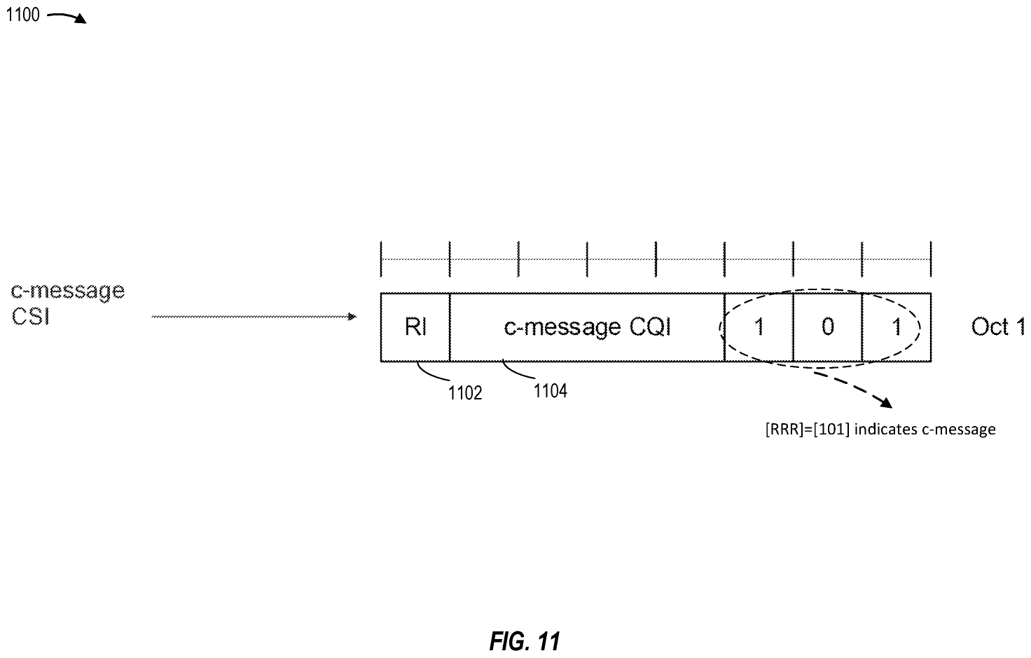

FIG. 11 depicts an example MAC-CE entry 1100 that may be used for c-message CSI reporting. As illustrated, the MAC CE entry 1100 may include one or more bits to convey an RI 1102 and a plurality of bits for a c-message CQI 1104. In the illustrated example R bit values of [1 0 1] may indicate the report is for c-message CSI. A transmitting device can use this reported information to adjust its transmission parameters, such as the transmit power and modulation scheme, to optimize the performance of the sidelink communication.

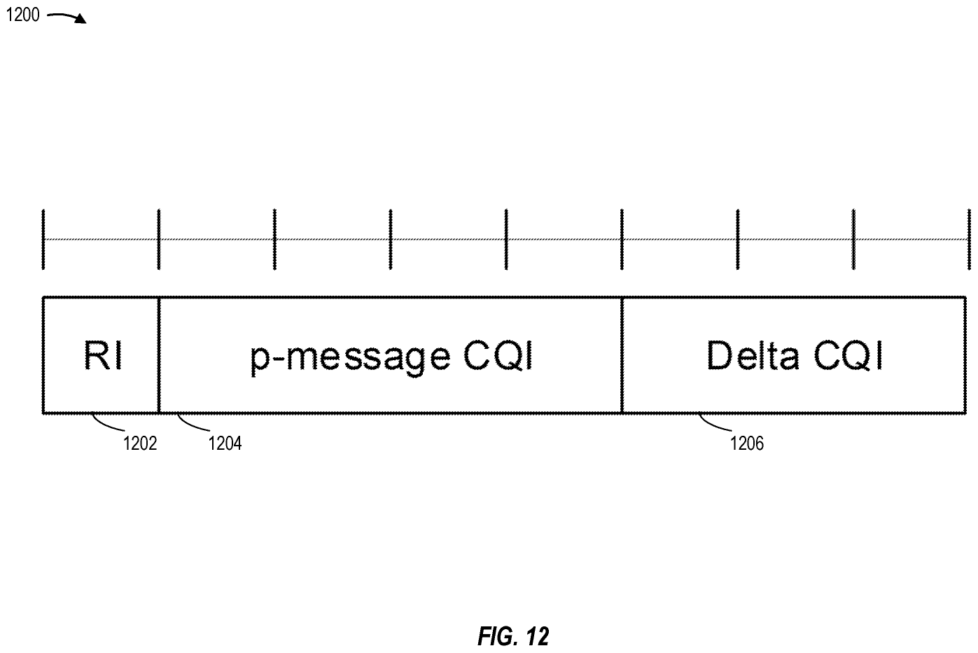

FIG. 12 depicts an example MAC-CE entry 1200 that may be used to report p-message and c-message CSI together. As illustrated in FIG. 12, the MAC-CE 1200 may include RI 1202, a p-message CQI 1204, and a delta CQI 1206 (e.g., in place of reserved bits) which may be used to determine the c-message CQI, relative to the p-message CQI. This format may allow Rx UEs to send the two CSI reports (p-message CSI and c-message CSI) in a single MAC-CE entry by leveraging the reserved bits partially or fully to send the delta.

For example, as illustrated in FIG. 12, 4 bits may be used to send p-message CQI (e.g., as in FIG. 10) and 3 bits (e.g., the reserved bits illustrated in FIG. 10) may be used to send the delta CQI, which may be used in combination with the p-message CQI in order to determine a c-message CQI. For example, in some cases, the delta CQI may be subtracted from the p-message CQI to yield the c-message CQI.

In some cases, 4 bits may be used to send c-message CQI (e.g., as in FIG. 11) and 3 bits (e.g., the reserved bits illustrated in FIG. 10) may be used to send the delta CQI, which may be used in combination with the c-message CQI in order to determine a p-message CQI. For example, in some cases, the delta CQI may be subtracted from the c-message CQI to yield the p-message CQI.

In some cases, p-message CQI and c-message CQI may be quantized at different bit widths and/or precisions. Quantization procedure and levels can be given in a wireless communication standard specification, or provided in radio resource control (RRC) or MAC-CE signals. A wireless communication standard specification may define multiple procedures, and one of the multiple procedures may be signaled in RRC/MAC-CE or sidelink control information (SCI).

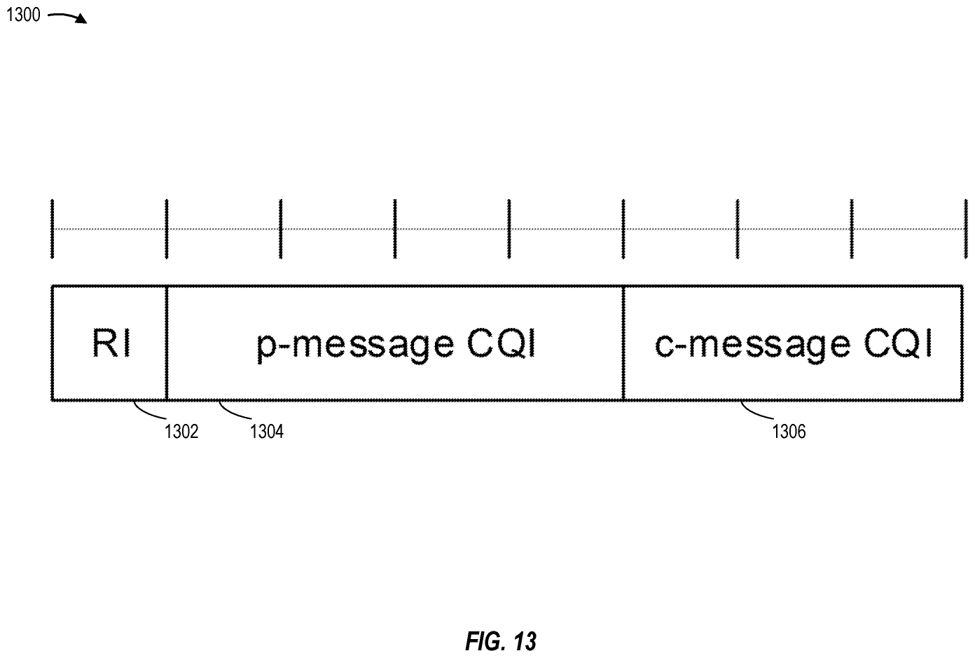

FIG. 13 depicts another example MAC-CE entry 1300 that may allow reporting p-message and c-message CSI together that may include RI 1302, a p-message CQI 1304, and a c-message CQI 1306 (e.g., in place of reserved bits).

The example illustrated in FIG. 13 gives the c-message 3 bits of CQI resolution while 4 bits of resolution are allocated for p-message CQI. This may be advantageous in many cases, since p-message CSI may be more important and may also have higher modulation and coding scheme (MCS) values (or be expected to have higher MCS values).

However, as discussed in further detail below, in some cases, c-message CQI may be allocated 4 bits of resolution while 3 bits of resolution may be allocated for p-message CQI.

Such a configuration of a MAC-CE entry may allow for the Tx-UE in SCI, based on configuration in RRC/MAC-CE, to change the resolution of each message. In the example illustrated in FIG. 13, there are 7 total bits. In some cases, Tx-UE may request the Rx-UE to use X bits for p-message and 7-X for c-message. In other cases, Tx-UE may select 4+y bits where y could be {1,2,3} to define the max CQI bits. The Tx-UE may then assign that 4+y bits to two sets: p-message CSI and c-message CSI.

This selection and assignment may be based on resource pool configuration performed by a network entity (e.g., a gNB). In some cases, the selection and assignment may be dynamically changed by gNB or by UEs. In some cases, the selection and assignment may also change based on layer 1, 2, and/or 3 (L1/L2/L3) indications from a network entity to Tx UE or other UEs.

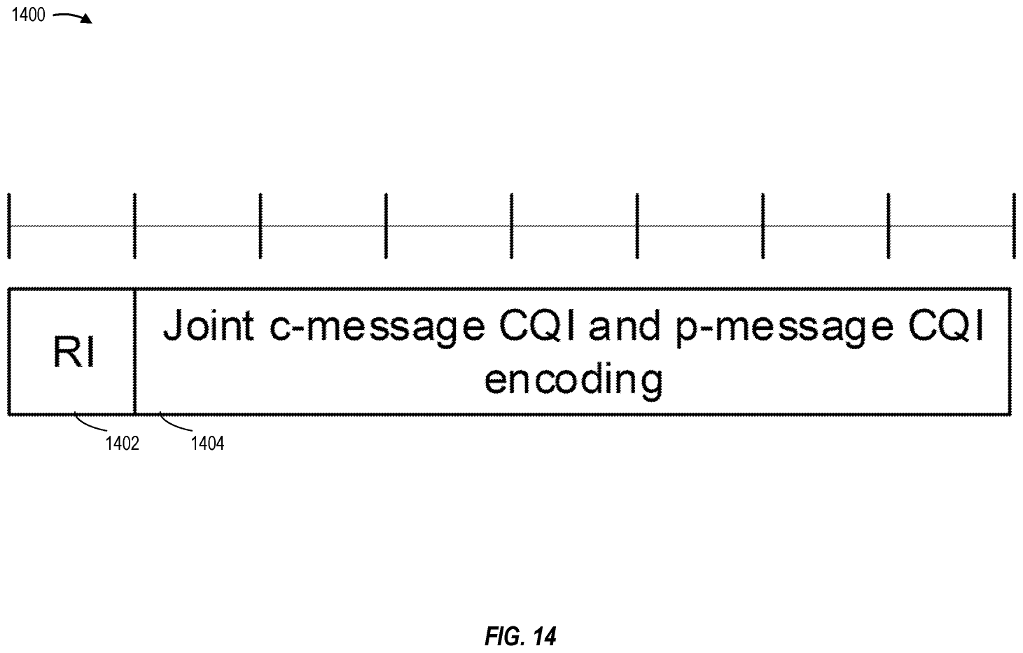

FIG. 14 depicts an example MAC-CE entry 1400 for a CSI report with c-message and p-message CQI jointly encoded. As illustrated, MAC-CE 1400 may include RI 1402 and a field 1404 for joint encoding of p-message CQI and c-message CQI. In some cases, this joint encoding may be based on one or more tables, for example. In some cases, the rank indicator for each of the p-message CSI and the c-message CSI may also be jointly encoded. As illustrated, in FIG. 14, the rank indicator (RI) may be allocated a single bit, while the joint encoding of p-message CQI and c-message CQI may be allocated 7 bits. In other cases, the bit width allocation for the rank indicator may be expanded as needed. In some cases, for example, 2 or 3 bits may be allocated for the rank indicator, and the joint encoding of p-message CQI and c-message CQI may be allocated 6 or 5 bits respectively, based on the bit allocation of the rank indicator.

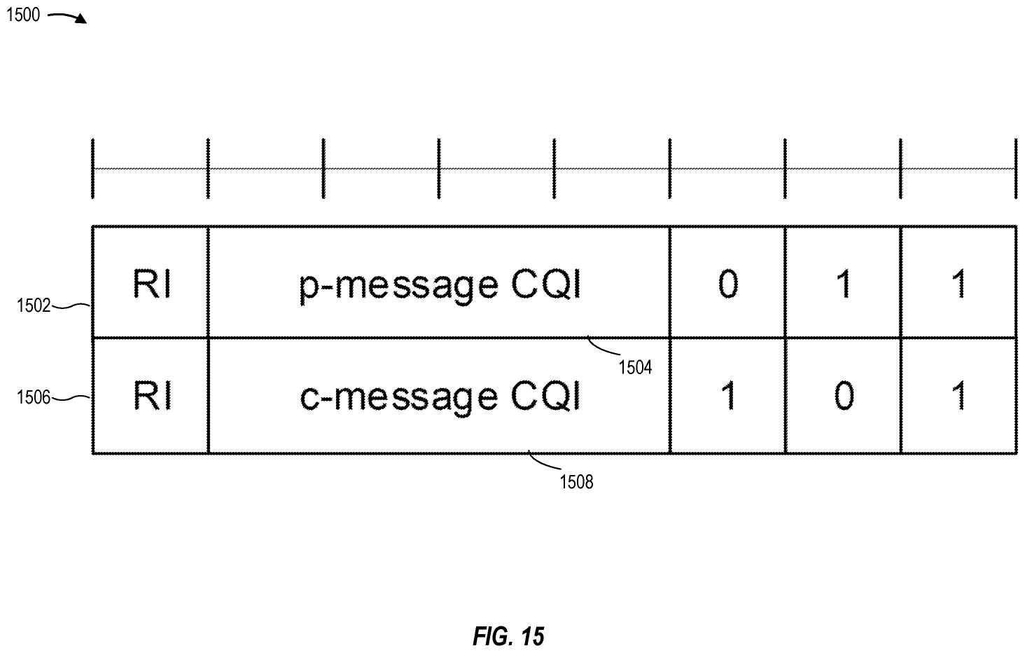

FIG. 15 depicts example a MAC-CE 1500 with multiple entries for p-message and c-message CSI reports. A first entry may include RI 1504 and p-message CQI 1504, while a second entry may include RI 1506 and c-message CQI 1508.

As described above, with respect to FIG. 10, first R bit values (e.g., ‘011’) may indicate the first entry is for p-message CSI, while second R bit values (e.g., ‘101’) may indicate the second entry is for c-message CSI.

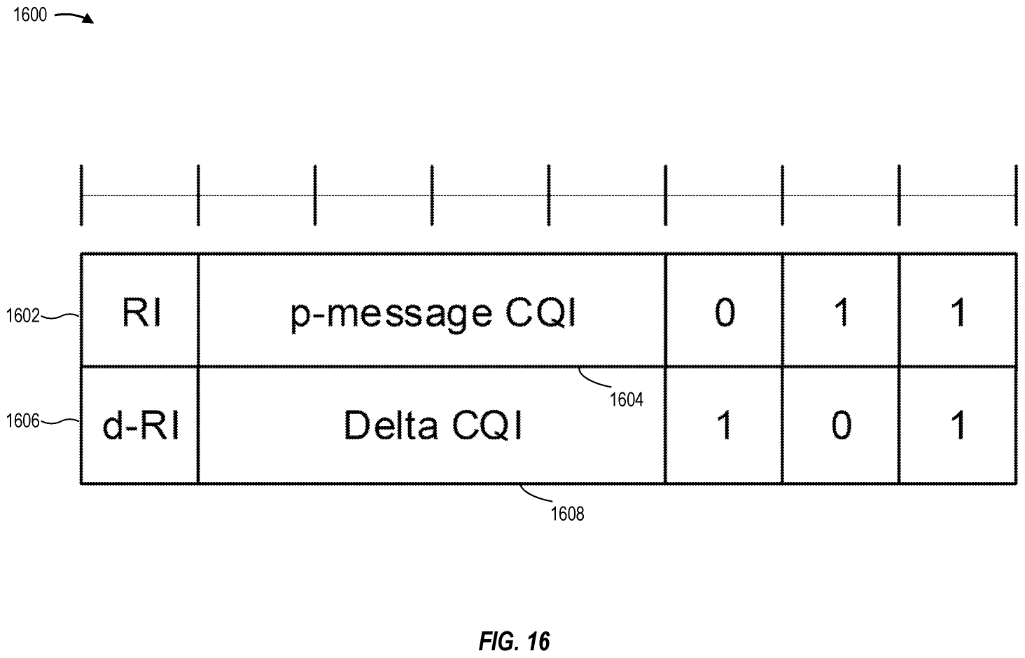

FIG. 16 depicts another example MAC-CE 1600 with multiple entries for CSI reports. As illustrated in FIG. 16, a first entry may include RI 1602 and p-message CQI 1604, while a second entry may include delta RI (d-RI) 1606 and delta CQI 1608 for c-message CSI.

As described with reference to FIG. 12. A delta CQI may be allocated 4 bits, as illustrated, and may be used (in addition to the first MAC-CE entry) to determine c-message CQI. For example, the delta CQI may be used in combination with the p-message CQI conveyed in the first MAC-CE entry in order to determine a c-message CQI. For example, in some cases, the delta CQI may be subtracted from the p-message CQI to yield the c-message CQI. In this way, the delta CQI may indicate c-message CQI or may be used to determine c-message CQI.

As illustrated, the second MAC-CE entry of the multi-entry MAC-CE 1600 may use a delta RI (d-RI). The d-RI may indicate a rank indicator for the second MAC-CE entry relative to the RI of the first MAC-CE entry. For example, in some cases, the d-RI of the second MAC-CE entry may be subtracted from the RI of the first MAC-CE entry, yielding an RI of the second MAC-CE entry.

In some cases, the first MAC-CE entry may be used to send c-message CQI (e.g., as in FIG. 11) and the delta CQI may be used in combination with the c-message CQI in order to determine a p-message CQI. For example, in some cases, the delta CQI may be subtracted from the c-message CQI to yield the p-message CQI.

As noted above, p-message CQI and c-message CQI may be quantized at different bit widths and/or precisions. Quantization procedure and levels can be given in a wireless communication standard specification, or provided in radio resource control (RRC) or MAC-CE signals. A wireless communication standard specification may define multiple procedures, and one of the multiple procedures may be signaled in RRC/MAC-CE or sidelink control information (SCI).

In some cases, CQI sub-channel bundling or subband reporting may be used for each message. For example, for a multi-entry MAC-CE, a different identifier may be used for each subband, and delta CQI may be specified relative to a wideband CQI for each message or each CQI. This may be done by leveraging the R bits. The resolution of each CSI report may change based on a message type. In some cases, the resolution may be based on a message type and L1/L2/L3 indications. In some cases, there could be conditions or values specified by a resource pool configuration (e.g., configured by a network entity) or specified by wireless communication standards specifications.

### Example Operations

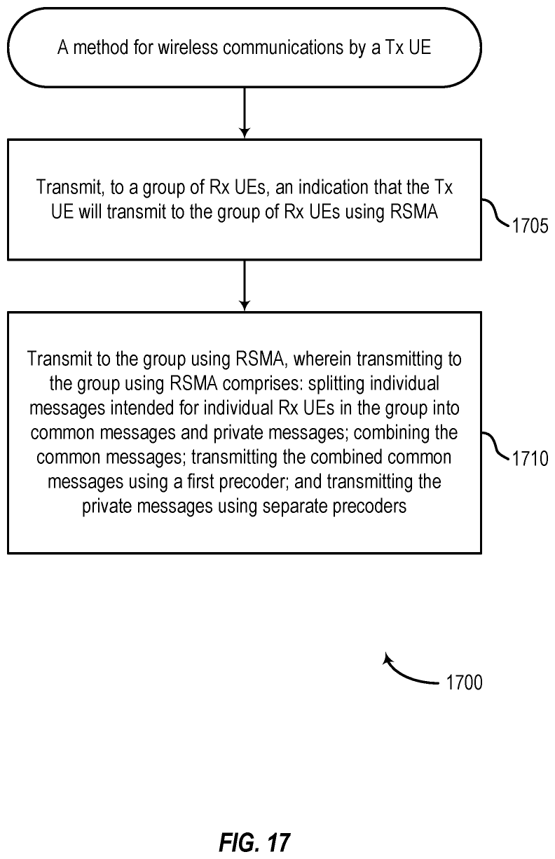

FIG. 17 shows an example of a method 1700 of wireless communication by a Tx UE, such as a UE 104 of FIGS. 1 and 3.

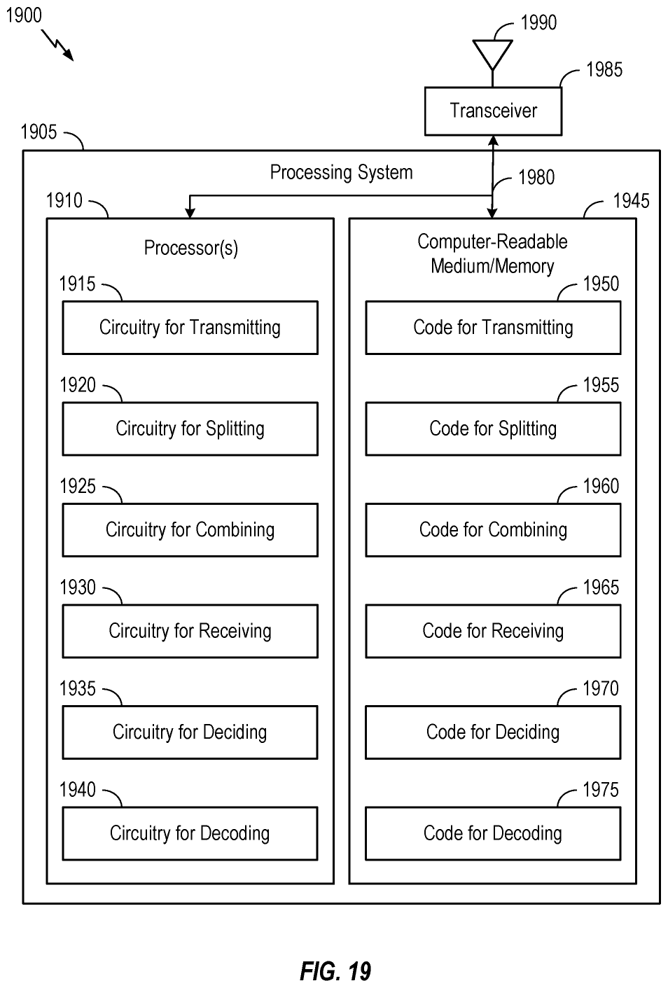

Method 1700 begins at step 1705 with transmitting, to a group of Rx UEs, an indication that the Tx UE will transmit to the group of Rx UEs using RSMA. In some cases, the operations of this step refer to, or may be performed by, circuitry for transmitting and/or code for transmitting as described with reference to FIG. 19.

Method 1700 then proceeds to step 1710 with transmitting to the group using RSMA, wherein transmitting to the group using RSMA comprises: splitting individual messages intended for individual Rx UEs in the group into common messages and private messages, combining the common messages, transmitting the combined common messages using a first precoder; and transmitting the private messages using separate precoders. In some cases, the operations of this step refer to, or may be performed by, circuitry for transmitting, code for transmitting, circuitry for splitting, code for splitting, circuitry for combining, and/or code for combining as described with reference to FIG. 19.

In some aspects, transmission to the group is on resources determined based, at least in part, on an entity that helped establish the resources.

In some aspects, one or more constraints are placed on resources that an Rx UE helped establish, the one or more constraints involving at least one of: using the resources for serving the Rx UE that helped establish the resources; a number of layers used for transmitting using RSMA; or using at least one certain transmission parameter for transmitting, using RSMA, to the Rx-UE that helped establish the resources.

In some aspects, the method 1700 further includes transmitting signaling requesting the Rx UEs to join the group. In some cases, the operations of this step refer to, or may be performed by, circuitry for transmitting and/or code for transmitting as described with reference to FIG. 19.

In some aspects, the method 1700 further includes receiving, from at least one of the Rx UEs, a response to the signaling. In some cases, the operations of this step refer to, or may be performed by, circuitry for receiving and/or code for receiving as described with reference to FIG. 19.

In some aspects, the method 1700 further includes receiving, from one or more of the Rx UEs, an indication of at least one of: capability information indicating a capability to perform rate splitting reception, the capability information indicating at least one of a number of streams supported for the private messages or a number of streams supported for the common messages; or an MCS, BLER, or combination thereof for the RSMA transmission. In some cases, the operations of this step refer to, or may be performed by, circuitry for receiving and/or code for receiving as described with reference to FIG. 19.

In some aspects, the capability information is obtained via at least one of: an RRC connection procedure; or a response to the signaling requesting the Rx UEs to join the group.

In some aspects, the method 1700 further includes deciding which Rx UEs to request to join the group based on at least one of a BLER, CSI report, CSI measurement, or reported capabilities. In some cases, the operations of this step refer to, or may be performed by, circuitry for deciding and/or code for deciding as described with reference to FIG. 19.

In some aspects, the method 1700 further includes receiving, from one or more of the Rx UEs, in response to the signaling a CSI report. In some cases, the operations of this step refer to, or may be performed by, circuitry for receiving and/or code for receiving as described with reference to FIG. 19.

In some aspects, the CSI report is based on at least one of SL-RSs transmitted with the signaling requesting the Rx UEs to join the group, previously transmitted DMRSs, or previously transmitted PSSCHs.

In some aspects, the signaling requesting the Rx UEs to join the group also indicates at least one of: a request for the Rx UEs to send the CSI report; or a request for the Rx UEs to transmit SRSs.

In some aspects, the signaling requesting the Rx UEs to join the group also indicates at least one of: a number of Rx UEs the Tx UE may transmit to using RSMA; or a list of potential Rx UEs the Tx UE may transmit to using RSMA.

In some aspects, transmitting to the group using RSMA is based on data availability for one or more of the Rx UEs in the group.

In some aspects, the method 1700 further includes receiving, from one or more of the Rx-UEs, CSI for RSMA, the CSI comprising: one or more bits for rank, a first plurality of bits associated with the common messages, and a second plurality of bits associated with the private messages. In some cases, the operations of this step refer to, or may be performed by, circuitry for receiving and/or code for receiving as described with reference to FIG. 19.

In some aspects, the common messages and private messages have at least one of: separately defined latency bounds for CSI reporting; or separately defined minimum CSI reporting times.

In some aspects, CSI associated with only one of the common messages or private messages is received in a single MAC CE entry; and one or more bits in the single MAC CE entry indicates whether the CSI is associated with the common messages or the private messages.

In some aspects, CSI associated with the common messages and private messages is received in a single MAC CE entry.

In some aspects, the MAC CE entry comprises: a first fixed number of bits for CSI associated with the common messages and a second fixed number of bits for CSI associated with the private messages; or a first configurable number of bits for CSI associated with the common messages and a second configurable number of bits for CSI associated with the private messages.

In some aspects, the MAC CE entry comprises: a first number of bits for first CSI associated with one of the common messages or the private messages; and a second number of bits indicating second CSI associated with the other of the common messages or the private messages, as a difference relative to the first CSI.

In some aspects, the MAC CE comprises a plurality of bits jointly encoding CSI associated with the common messages and private messages.

In some aspects, CSI associated with the common messages and private messages is received as separate entries in a MAC CE.

In some aspects, the MAC CE comprises: a first entry with first CSI associated with one of the common messages or the private messages; and a second entry indicating second CSI associated with the other of the common messages or the private messages, as a difference relative to the first CSI.

In some aspects, the CSI associated with at least one of the common messages or private messages comprises at least one of sub-channel bundle or subband CSI.

In some aspects, CSI associated with different sub-channel bundles or subbands is received as separate entries in a MAC CE.

In one aspect, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative steps are possible consistent with this disclosure.

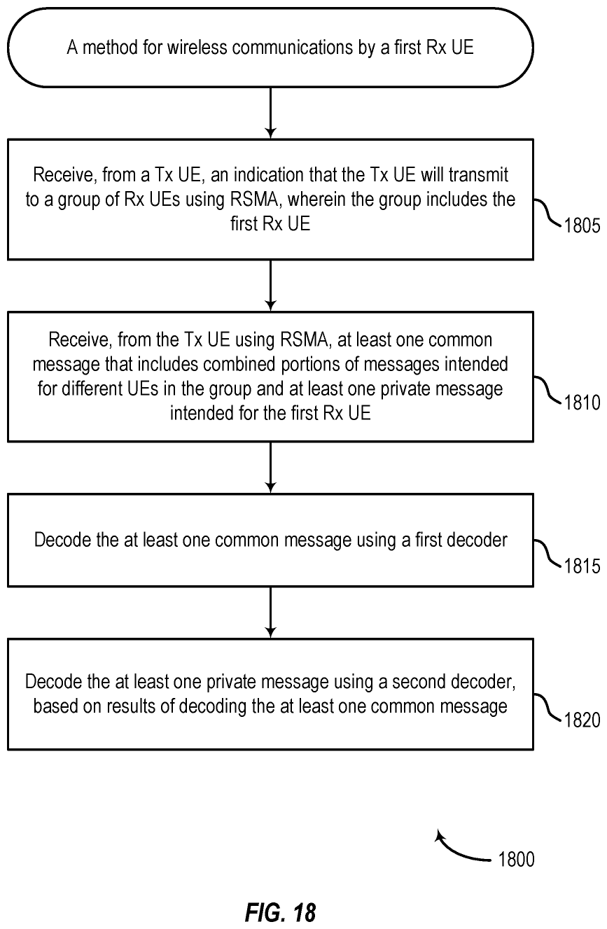

FIG. 18 shows an example of a method 1800 of wireless communication by a first Rx UE, such as a UE 104 of FIGS. 1 and 3.

Method 1800 begins at step 1805 with receiving, from a Tx UE, an indication that the Tx UE will transmit to a group of Rx UEs using RSMA, wherein the group includes the first Rx UE. In some cases, the operations of this step refer to, or may be performed by, circuitry for receiving and/or code for receiving as described with reference to FIG. 19.

Method 1800 then proceeds to step 1810 with receiving, from the Tx UE using RSMA, at least one common message that includes combined portions of messages intended for different UEs in the group and at least one private message intended for the first Rx UE. In some cases, the operations of this step refer to, or may be performed by, circuitry for receiving and/or code for receiving as described with reference to FIG. 19.

Method 1800 then proceeds to step 1815 with decoding the at least one common message using a first decoder. In some cases, the operations of this step refer to, or may be performed by, circuitry for decoding and/or code for decoding as described with reference to FIG. 19.

Method 1800 then proceeds to step 1820 with decoding the at least one private message using a second decoder, based on results of decoding the at least one common message. In some cases, the operations of this step refer to, or may be performed by, circuitry for decoding and/or code for decoding as described with reference to FIG. 19.

In some aspects, the method 1800 further includes receiving signaling requesting the first Rx UE to join the group. In some cases, the operations of this step refer to, or may be performed by, circuitry for receiving and/or code for receiving as described with reference to FIG. 19.

In some aspects, the method 1800 further includes transmitting, to the Tx UE, a response to the signaling. In some cases, the operations of this step refer to, or may be performed by, circuitry for transmitting and/or code for transmitting as described with reference to FIG. 19.

In some aspects, the method 1800 further includes transmitting, to the Tx UE, an indication of at least one of: capability information indicating a capability to perform rate splitting reception, the capability information indicating at least one of a number of streams supported for the at least one private message or a number of streams supported for the at least one common message; or an MCS, BLER, or combination thereof for RSMA transmission. In some cases, the operations of this step refer to, or may be performed by, circuitry for transmitting and/or code for transmitting as described with reference to FIG. 19.

In some aspects, the capability information is transmitted via at least one of: an RRC connection procedure; or a response to the signaling requesting the first Rx UE to join the group.

In some aspects, the method 1800 further includes transmitting a CSI report to the Tx UE in response to the signaling. In some cases, the operations of this step refer to, or may be performed by, circuitry for transmitting and/or code for transmitting as described with reference to FIG. 19.

In some aspects, the CSI report is based on at least one of SL-RSs transmitted with the signaling requesting the first Rx UE to join the group, previously transmitted DMRSs, or previously transmitted PSSCHs.

In some aspects, the signaling requesting the first Rx UE to join the group also indicates at least one of: a request for the first Rx UE to send the CSI report; or a request for the first Rx UE to transmit SRSs.

In some aspects, the signaling requesting the first Rx UE to join the group also indicates at least one of: a number of Rx UEs the Tx UE may transmit to using RSMA; or a list of potential Rx UEs the Tx UE may transmit to using RSMA.

In some aspects, the method 1800 further includes transmitting, to the Tx UE, CSI for RSMA, the CSI comprising: one or more bits for rank, a first plurality of bits associated with the at least one common message, and a second plurality of bits associated with the at least one private message. In some cases, the operations of this step refer to, or may be performed by, circuitry for transmitting and/or code for transmitting as described with reference to FIG. 19.

In some aspects, the at least one common message and the at least one private message have at least one of: separately defined latency bounds for CSI reporting; or separately defined minimum CSI reporting times.

In some aspects, CSI associated with only one of the at least one common message or the at least one private message is transmitted in a single MAC CE entry; and one or more bits in the single MAC CE entry indicates whether the CSI is associated with the at least one common message or the at least one private message.

In some aspects, CSI associated with the at least one common message and the at least one private message is transmitted in a single MAC CE entry.

In some aspects, the MAC CE entry comprises: a first fixed number of bits for CSI associated with the at least one common message and a second fixed number of bits for CSI associated with the at least one private message; or a first configurable number of bits for CSI associated with the at least one common message and a second configurable number of bits for CSI associated with the at least one private message.

In some aspects, the MAC CE entry comprises: a first number of bits for first CSI associated with one of the at least one common message or the at least one private message; and a second number of bits indicating second CSI associated with the other of the at least one common message or the at least one private message, as a difference relative to the first CSI.

In some aspects, the MAC CE comprises a plurality of bits jointly encoding CSI associated with the at least one common message and the at least one private message.

In some aspects, CSI associated with the at least one common message and the at least one private message is received as separate entries in a MAC CE.

In some aspects, the MAC CE comprises: a first entry with first CSI is associated with one of the at least one common message or the at least one private message; and a second entry indicating second CSI associated with the other of the at least one common message or the at least one private message, as a difference relative to the first CSI.

In some aspects, the CSI associated with at least one of at least one common message or the at least one private message comprises at least one of sub-channel bundle or subband CSI.

In some aspects, CSI associated with different sub-channel bundles or subbands is received as separate entries in a MAC CE.

In one aspect, method 1800, or any aspect related to it, may be performed by an apparatus, such as communications device 1900 of FIG. 19, which includes various components operable, configured, or adapted to perform the method 1800. Communications device 1900 is described below in further detail.

Note that FIG. 18 is just one example of a method, and other methods including fewer, additional, or alternative steps are possible consistent with this disclosure.

### Example Communications Device

FIG. 19 depicts aspects of an example communications device 1900. In some aspects, communications device 1900 is a user equipment, such as UE 104 described above with respect to FIGS. 1 and 3.

The communications device 1900 includes a processing system 1905 coupled to the transceiver 1985 (e.g., a transmitter and/or a receiver). The transceiver 1985 is configured to transmit and receive signals for the communications device 1900 via the antenna 1990, such as the various signals as described herein. The processing system 1905 may be configured to perform processing functions for the communications device 1900, including processing signals received and/or to be transmitted by the communications device 1900.

The processing system 1905 includes one or more processors 1910. In various aspects, the one or more processors 1910 may be representative of one or more of receive processor 358, transmit processor 364, TX MIMO processor 366, and/or controller/processor 380, as described with respect to FIG. 3. The one or more processors 1910 are coupled to a computer-readable medium/memory 1945 via a bus 1980. In certain aspects, the computer-readable medium/memory 1945 is configured to store instructions (e.g., computer-executable code) that when executed by the one or more processors 1910, cause the one or more processors 1910 to perform the method 1700 described with respect to FIG. 17, or any aspect related to it; and the method 1800 described with respect to FIG. 18, or any aspect related to it. Note that reference to a processor performing a function of communications device 1900 may include one or more processors 1910 performing that function of communications device 1900.

In the depicted example, computer-readable medium/memory 1945 stores code (e.g., executable instructions), such as code for transmitting 1950, code for splitting 1955, code for combining 1960, code for receiving 1965, code for deciding 1970, and code for decoding 1975. Processing of the code for transmitting 1950, code for splitting 1955, code for combining 1960, code for receiving 1965, code for deciding 1970, and code for decoding 1975 may cause the communications device 1900 to perform the method 1700 described with respect to FIG. 17, or any aspect related to it; and the method 1800 described with respect to FIG. 18, or any aspect related to it.

The one or more processors 1910 include circuitry configured to implement (e.g., execute) the code stored in the computer-readable medium/memory 1945, including circuitry such as circuitry for transmitting 1915, circuitry for splitting 1920, circuitry for combining 1925, circuitry for receiving 1930, circuitry for deciding 1935, and circuitry for decoding 1940. Processing with circuitry for transmitting 1915, circuitry for splitting 1920, circuitry for combining 1925, circuitry for receiving 1930, circuitry for deciding 1935, and circuitry for decoding 1940 may cause the communications device 1900 to perform the method 1700 described with respect to FIG. 17, or any aspect related to it; and the method 1800 described with respect to FIG. 18, or any aspect related to it.

Various components of the communications device 1900 may provide means for performing the method 1700 described with respect to FIG. 17, or any aspect related to it; and the method 1800 described with respect to FIG. 18, or any aspect related to it. For example, means for transmitting, sending or outputting for transmission may include transceivers 354 and/or antenna(s) 352 of the UE 104 illustrated in FIG. 3 and/or the transceiver 1985 and the antenna 1990 of the communications device 1900 in FIG. 19. Means for receiving or obtaining may include transceivers 354 and/or antenna(s) 352 of the UE 104 illustrated in FIG. 3 and/or the transceiver 1985 and the antenna 1990 of the communications device 1900 in FIG. 19.

### Example Clauses

Implementation examples are described in the following numbered clauses:

Clause 1: A method for wireless communications by a Tx UE, comprising: transmitting, to a group of Rx UEs, an indication that the Tx UE will transmit to the group of Rx UEs using RSMA; transmitting to the group using RSMA, wherein transmitting to the group using RSMA comprises: splitting individual messages intended for individual Rx UEs in the group into common messages and private messages; combining the common messages; transmitting the combined common messages using a first precoder; and transmitting the private messages using separate precoders.

Clause 2: The method of Clause 1, wherein: transmission to the group is on resources determined based, at least in part, on an entity that helped establish the resources.

Clause 3: The method of Clause 2, wherein one or more constraints are placed on resources that an Rx UE helped establish, the one or more constraints involving at least one of: using the resources for serving the Rx UE that helped establish the resources; a number of layers used for transmitting using RSMA; or using at least one certain transmission parameter for transmitting, using RSMA, to the Rx-UE that helped establish the resources.

Clause 4: The method of any one of Clauses 1-3, further comprising: transmitting signaling requesting the Rx UEs to join the group; and receiving, from at least one of the Rx UEs, a response to the signaling.

Clause 5: The method of Clause 4, further comprising: receiving, from one or more of the Rx UEs, an indication of at least one of: capability information indicating a capability to perform rate splitting reception, the capability information indicating at least one of a number of streams supported for the private messages or a number of streams supported for the common messages; or an MCS, BLER, or combination thereof for the RSMA transmission.

Clause 6: The method of Clause 5, wherein the capability information is obtained via at least one of: an RRC connection procedure; or a response to the signaling requesting the Rx UEs to join the group.

Clause 7: The method of Clause 5, further comprising: deciding which Rx UEs to request to join the group based on at least one of a BLER, CSI report, CSI measurement, or reported capabilities.

Clause 8: The method of Clause 4, further comprising: receiving, from one or more of the Rx UEs, in response to the signaling a CSI report.

Clause 9: The method of Clause 8, wherein the CSI report is based on at least one of SL-RSs transmitted with the signaling requesting the Rx UEs to join the group, previously transmitted DMRSs, or previously transmitted PSSCHs.

Clause 10: The method of Clause 8, wherein the signaling requesting the Rx UEs to join the group also indicates at least one of: a request for the Rx UEs to send the CSI report; or a request for the Rx UEs to transmit SRSs.

Clause 11: The method of Clause 8, wherein the signaling requesting the Rx UEs to join the group also indicates at least one of: a number of Rx UEs the Tx UE may transmit to using RSMA; or a list of potential Rx UEs the Tx UE may transmit to using RSMA.

Clause 12: The method of Clause 11, wherein transmitting to the group using RSMA is based on data availability for one or more of the Rx UEs in the group.

Clause 13: The method of any one of Clauses 1-12, further comprising: receiving, from one or more of the Rx-UEs, CSI for RSMA, the CSI comprising: one or more bits for rank, a first plurality of bits associated with the common messages, and a second plurality of bits associated with the private messages.

Clause 14: The method of Clause 13, wherein the common messages and private messages have at least one of: separately defined latency bounds for CSI reporting; or separately defined minimum CSI reporting times.

Clause 15: The method of Clause 13, wherein: CSI associated with only one of the common messages or private messages is received in a single MAC CE entry; and one or more bits in the single MAC CE entry indicates whether the CSI is associated with the common messages or the private messages.

Clause 16: The method of Clause 13, wherein CSI associated with the common messages and private messages is received in a single MAC CE entry.

Clause 17: The method of Clause 16, wherein the MAC CE entry comprises: a first fixed number of bits for CSI associated with the common messages and a second fixed number of bits for CSI associated with the private messages; or a first configurable number of bits for CSI associated with the common messages and a second configurable number of bits for CSI associated with the private messages.

Clause 18: The method of Clause 16, wherein the MAC CE entry comprises: a first number of bits for first CSI associated with one of the common messages or the private messages; and a second number of bits indicating second CSI associated with the other of the common messages or the private messages, as a difference relative to the first CSI.

Clause 19: The method of Clause 16, wherein the MAC CE comprises a plurality of bits jointly encoding CSI associated with the common messages and private messages.

Clause 20: The method of Clause 13, wherein CSI associated with the common messages and private messages is received as separate entries in a MAC CE.

Clause 21: The method of Clause 20, wherein the MAC CE comprises: a first entry with first CSI associated with one of the common messages or the private messages; and a second entry indicating second CSI associated with the other of the common messages or the private messages, as a difference relative to the first CSI.

Clause 22: The method of Clause 13, wherein the CSI associated with at least one of the common messages or private messages comprises at least one of sub-channel bundle or subband CSI.

Clause 23: The method of Clause 13, wherein CSI associated with different sub-channel bundles or subbands is received as separate entries in a MAC CE.

Clause 24: A method for wireless communications by a first Rx UE, comprising: receiving, from a Tx UE, an indication that the Tx UE will transmit to a group of Rx UEs using RSMA, wherein the group includes the first Rx UE; receiving, from the Tx UE using RSMA, at least one common message that includes combined portions of messages intended for different UEs in the group and at least one private message intended for the first Rx UE; decoding the at least one common message using a first decoder; and decoding the at least one private message using a second decoder, based on results of decoding the at least one common message.

Clause 25: The method of Clause 24, further comprising: receiving signaling requesting the first Rx UE to join the group; and transmitting, to the Tx UE, a response to the signaling.

Clause 26: The method of Clause 25, further comprising: transmitting, to the Tx UE, an indication of at least one of: capability information indicating a capability to perform rate splitting reception, the capability information indicating at least one of a number of streams supported for the at least one private message or a number of streams supported for the at least one common message; or an MCS, BLER, or combination thereof for RSMA transmission.

Clause 27: The method of Clause 26, wherein the capability information is transmitted via at least one of: an RRC connection procedure; or a response to the signaling requesting the first Rx UE to join the group.

Clause 28: The method of Clause 25, further comprising: transmitting a CSI report to the Tx UE in response to the signaling.

Clause 29: The method of Clause 28, wherein the CSI report is based on at least one of SL-RSs transmitted with the signaling requesting the first Rx UE to join the group, previously transmitted DMRSs, or previously transmitted PSSCHs.

Clause 30: The method of Clause 28, wherein the signaling requesting the first Rx UE to join the group also indicates at least one of: a request for the first Rx UE to send the CSI report; or a request for the first Rx UE to transmit SRSs.

Clause 31: The method of Clause 28, wherein the signaling requesting the first Rx UE to join the group also indicates at least one of: a number of Rx UEs the Tx UE may transmit to using RSMA; or a list of potential Rx UEs the Tx UE may transmit to using RSMA.

Clause 32: The method of any one of Clauses 24-31, further comprising: transmitting, to the Tx UE, CSI for RSMA, the CSI comprising: one or more bits for rank, a first plurality of bits associated with the at least one common message, and a second plurality of bits associated with the at least one private message.

Clause 33: The method of Clause 32, wherein the at least one common message and the at least one private message have at least one of: separately defined latency bounds for CSI reporting; or separately defined minimum CSI reporting times.

Clause 34: The method of Clause 32, wherein: CSI associated with only one of the at least one common message or the at least one private message is transmitted in a single MAC CE entry; and one or more bits in the single MAC CE entry indicates whether the CSI is associated with the at least one common message or the at least one private message.

Clause 35: The method of Clause 32, wherein CSI associated with the at least one common message and the at least one private message is transmitted in a single MAC CE entry.

Clause 36: The method of Clause 35, wherein the MAC CE entry comprises: a first fixed number of bits for CSI associated with the at least one common message and a second fixed number of bits for CSI associated with the at least one private message; or a first configurable number of bits for CSI associated with the at least one common message and a second configurable number of bits for CSI associated with the at least one private message.

Clause 37: The method of Clause 35, wherein the MAC CE entry comprises: a first number of bits for first CSI associated with one of the at least one common message or the at least one private message; and a second number of bits indicating second CSI associated with the other of the at least one common message or the at least one private message, as a difference relative to the first CSI.

Clause 38: The method of Clause 35, wherein the MAC CE comprises a plurality of bits jointly encoding CSI associated with the at least one common message and the at least one private message.

Clause 39: The method of Clause 32, wherein CSI associated with the at least one common message and the at least one private message is received as separate entries in a MAC CE.

Clause 40: The method of Clause 39, wherein the MAC CE comprises: a first entry with first CSI is associated with one of the at least one common message or the at least one private message; and a second entry indicating second CSI associated with the other of the at least one common message or the at least one private message, as a difference relative to the first CSI.

Clause 41: The method of Clause 32, wherein the CSI associated with at least one of at least one common message or the at least one private message comprises at least one of sub-channel bundle or subband CSI.

Clause 42: The method of Clause 32, wherein CSI associated with different sub-channel bundles or subbands is received as separate entries in a MAC CE.

Clause 43: An apparatus, comprising: a memory comprising executable instructions; and a processor configured to execute the executable instructions and cause the apparatus to perform a method in accordance with any one of Clauses 1-42.

Clause 44: An apparatus, comprising means for performing a method in accordance with any one of Clauses 1-42.

Clause 45: A non-transitory computer-readable medium comprising executable instructions that, when executed by a processor of an apparatus, cause the apparatus to perform a method in accordance with any one of Clauses 1-42.

Clause 46: A computer program product embodied on a computer-readable storage medium comprising code for performing a method in accordance with any one of Clauses 1-42.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a transmitter (Tx) user equipment (UE), comprising:
transmitting, to a group of receiver UEs (Rx UEs), an indication that the Tx UE will transmit to the group of Rx UEs using rate splitting multiple access (RSMA); and
transmitting to the group using RSMA, wherein transmitting to the group using RSMA comprises:
splitting individual messages intended for individual Rx UEs in the group into common messages and private messages;
combining the common messages;
transmitting the combined common messages using a first precoder; and
transmitting the private messages using separate precoders.

2. The method of claim 1, wherein:
transmission to the group is on resources determined based, at least in part, on an entity that helped establish the resources.

3. The method of claim 2, wherein one or more constraints are placed on resources that an Rx UE helped establish, the one or more constraints involving at least one of:
using the resources for serving the Rx UE that helped establish the resources;
a number of layers used for transmitting using RSMA; or
using at least one certain transmission parameter for transmitting, using RSMA, to the Rx-UE that helped establish the resources.

4. The method of claim 1, further comprising:
transmitting signaling requesting the Rx UEs to join the group; and
receiving, from at least one of the Rx UEs, a response to the signaling.

5. The method of claim 4, further comprising receiving, from one or more of the Rx UEs, an indication of at least one of:
capability information indicating a capability to perform rate splitting reception, the capability information indicating at least one of a number of streams supported for the private messages or a number of streams supported for the common messages; or
a modulation and coding scheme (MCS), block error rate (BLER), or combination thereof for an RSMA transmission.

6. The method of claim 5, wherein the capability information is obtained via at least one of:
a radio resource control (RRC) connection procedure; or
a response to the signaling requesting the Rx UEs to join the group.

7. The method of claim 5, further comprising deciding which Rx UEs to request to join the group based on at least one of a block error rate (BLER), channel state information (CSI) report, CSI measurement, or reported capabilities.

8. The method of claim 4, further comprising receiving, from one or more of the Rx UEs, in response to the signaling a channel state information (CSI) report.

9. The method of claim 8, wherein the CSI report is based on at least one of sidelink reference signals (SL-RS) transmitted with the signaling requesting the Rx UEs to join the group, previously transmitted demodulation reference signals (DMRS), or previously transmitted physical sidelink shared channel (PSSCHs).

10. The method of claim 8, wherein the signaling requesting the Rx UEs to join the group also indicates at least one of:
a request for the Rx UEs to send the CSI report; or
a request for the Rx UEs to transmit sounding reference signals (SRS).

11. The method of claim 8, wherein the signaling requesting the Rx UEs to join the group also indicates at least one of:
a number of Rx UEs the Tx UE may transmit to using RSMA; or
a list of potential Rx UEs the Tx UE may transmit to using RSMA.

12. The method of claim 11, wherein transmitting to the group using RSMA is based on data availability for one or more of the Rx UEs in the group.

13. The method of claim 1, further comprising receiving, from one or more of the Rx-UEs, channel state information (CSI) for RSMA, the CSI comprising:
one or more bits for rank,
a first plurality of bits associated with the common messages, and
a second plurality of bits associated with the private messages.

14. The method of claim 13, wherein the common messages and private messages have at least one of:
separately defined latency bounds for CSI reporting; or
separately defined minimum CSI reporting times.

15. The method of claim 13, wherein:
CSI associated with only one of the common messages or private messages is received in a single medium access control (MAC) control element (CE) entry; and
one or more bits in the single MAC CE entry indicates whether the CSI is associated with the common messages or the private messages.

16. The method of claim 13, wherein CSI associated with the common messages and private messages is received in a single medium access control (MAC) control element (CE) entry.

17. The method of claim 16, wherein the MAC CE entry comprises:
a first fixed number of bits for CSI associated with the common messages and a second fixed number of bits for CSI associated with the private messages; or
a first configurable number of bits for CSI associated with the common messages and a second configurable number of bits for CSI associated with the private messages.

18. The method of claim 16, wherein the MAC CE entry comprises:
a first number of bits for first CSI associated with one of the common messages or the private messages; and
a second number of bits indicating second CSI associated with the other of the common messages or the private messages, as a difference relative to the first CSI.

19. The method of claim 16, wherein the MAC CE comprises a plurality of bits jointly encoding CSI associated with the common messages and private messages.

20. The method of claim 13, wherein:
CSI associated with the common messages and private messages is received as separate entries in a medium access control (MAC) control element (CE);
a first entry with first CSI associated with one of the common messages or the private messages; and
a second entry indicating second CSI associated with the other of the common messages or the private messages, as a difference relative to the first CSI.

21. The method of claim 13, wherein:
the CSI associated with at least one of the common messages or private messages comprises at least one of sub-channel bundle CSI or subband CSI.

22. A method for wireless communications by a first receiver (Rx) user equipment (UE), comprising:
receiving, from a transmitter (Tx) UE, an indication that the Tx UE will transmit to a group of Rx UEs using rate splitting multiple access (RSMA), wherein the group includes the first Rx UE;
receiving, from the Tx UE using RSMA, at least one common message that includes combined portions of messages intended for different UEs in the group and at least one private message intended for the first Rx UE;
decoding the at least one common message using a first decoder; and
decoding the at least one private message using a second decoder, based on results of decoding the at least one common message.

23. The method of claim 22, further comprising:
receiving signaling requesting the first Rx UE to join the group; and
transmitting, to the Tx UE, a response to the signaling.

24. The method of claim 22, further comprising transmitting, to the Tx UE, channel state information (CSI) for RSMA, the CSI comprising:
one or more bits for rank,
a first plurality of bits associated with the at least one common message, and
a second plurality of bits associated with the at least one private message.

25. The method of claim 24, wherein:
CSI associated with only one of the at least one common message or the at least one private message is transmitted in a single medium access control (MAC) control element (CE) entry; and
one or more bits in the single MAC CE entry indicates whether the CSI is associated with the at least one common message or the at least one private message.

26. The method of claim 24, wherein CSI associated with the at least one common message and the at least one private message is transmitted in a single medium access control (MAC) control element (CE) entry.

27. The method of claim 26, wherein the MAC CE comprises a plurality of bits jointly encoding CSI associated with the at least one common message and the at least one private message.

28. The method of claim 24, wherein CSI associated with the at least one common message and the at least one private message is received as separate entries in a medium access control (MAC) control element (CE).

29. An apparatus for wireless communication at a transmitter user equipment (UE), comprising: a memory comprising computer-executable instructions; and one or more processors configured to execute the computer-executable instructions and cause the apparatus to:
transmit, to a group of receiver UEs (Rx UEs), an indication that the Tx UE will transmit to the group of Rx UEs using rate splitting multiple access (RSMA); and
transmit to the group using RSMA, wherein transmitting to the group using RSMA comprises:
splitting individual messages intended for individual Rx UEs in the group into common messages and private messages;
combining the common messages;
transmitting the combined common messages using a first precoder; and
transmitting the private messages using separate precoders.

30. An apparatus for wireless communication at a first receiver (Rx) user equipment (UE), comprising: a memory comprising computer-executable instructions; and one or more processors configured to execute the computer-executable instructions and cause the apparatus to:
receive, from a transmitter (Tx) UE, an indication that the Tx UE will transmit to a group of Rx UEs using rate splitting multiple access (RSMA), wherein the group includes the first Rx UE;
receive, from the Tx UE using RSMA, at least one common message that includes combined portions of messages intended for different UEs in the group and at least one private message intended for the first Rx UE;
decode the at least one common message using a first decoder; and
decode the at least one private message using a second decoder, based on results of decoding the at least one common message.
